(19) United States
(12) Patent Application Publication
(10) Pub. No.: US 2006/0171534 A1
(43) Pub. Date: Aug. 3, 2006

(54) Variable key encryption using multi-dimensional arrays

(76) Inventor: William P. Baughman, New York, NJ (US)

Correspondence Address: DAVID PETER ALAN, ESQ., 81 Second St., South Orange, NJ, 07079, US

(21) Appl. No.: 11/048,022

(22) Filed: Jan. 31, 2005

(51) Int. Cl. H04L 9/00

(52) U.S. Cl. 380/47

(57) ABSTRACT

A method is disclosed for encrypting messages for secure transmission over the Internet, for decryption by the receiver of such messages. The key used to encode each character of the message changes continually, in response to both its position after encoding the previous character and the identity of the previous character encoded. This continual change in the coding key yields essentially separate codes for every character of the message to be encoded, thereby making it more difficult to break codes imparted in the method described here than had prevailed in previous codes. The key is stored as a four-dimensional array, which is altered every time any character is encoded. If random data is generated and added to the beginning of the plaintext before it is encrypted, this code is capable of encrypting the message using random data unknown to the receiver, in such a way that the receiver can still decrypt the message.

### FIELD OF THE INVENTION

This invention relates to encryption of sensitive data for transmission in a secured manner over the Internet or through other media. The method described continually changes the encoding key in response to each unit of data encoded, depending on the content of the data and the current state of the key.

### BACKGROUND OF THE INVENTION

Security of information is becoming increasingly important in the world today, whether for governmental, business or personal reasons. With most records now kept on computers and information transmitted through the Internet, it is becoming increasingly vital that information be transmitted from one computer to another in a secure manner. There have been numerous developments in the encryption field, and these developments are needed to keep one step ahead of code-breakers whose intent is to gain access to information that they are not authorized to have.

Early codes were simple. While they provided a greater level of security than was available by disseminating plaintext messages (which afforded no security at all), they were easy to decipher. A monoalphabetic substitution code, such as the cryptogram puzzles in newspapers, is sufficiently easy to break that casual hobbyists do it for recreation.

Codes have become far more sophisticated over the years. The Enigma code, used by the German military during World War II, featured coding keys that changed on their own, during the transmission of information. The Allies eventually cracked the Enigma code, but with great effort and difficulty. Today's encryption (and code-cracking) methods for computer-transmitted data are far more sophisticated than those of only a few years ago.

In the present invention, the encryption method described is considered “Variable” because the coding key constantly changes, in response to the data that it encodes (each character or each byte of a block, file or data stream, for example).

Recent prior art includes different encryption methods, but none of these methods feature a key that changes according to the specific unit of data to be encoded. Rivest, (U.S. Pat. No. 5,724,428) involves changing plaintext data using intermediate encryption results. (Graunke, U.S. Pat. No. 6,804,355) uses look-up tables for encoding purposes. Luyster (U.S. Pat. Nos. 6,751,319 and 6,578,150) introduces a non-linear one-to-one function dependent on other data from within a different part of the same block of data, but does not shuffle or alter the key, as does the present invention. Yoshiura (U.S. Pat. No. 6,504,931) creates new keys for different blocks of input data based on the input data, but the function for creating those keys remains the same, and those keys never change. Ohmori (U.S. Pat. No. 6,459,792) merges some encrypted data from blocks into other blocks that come later, but it does not change the key in accordance with data. Coppersmith, (U.S. Pat. No. 6,243,470) uses different subkeys every round, but they are pre-computed and are not continually variable. Rivest (U.S. Pat. No. 5,835,600) looks at data to determine a number of rotations, but it does not change the key as data is encoded. In the present invention, the key actually changes with its position at the time of encoding each specific unit of data, and the identity of the next unit of data to be encoded. This feature is not found in the prior art inventions.

Because of the particular strengths of the invention described here, the codes used in the practice of the invention are particularly suited for applications in companies and institutions that send massive numbers of nearly identical messages, or messages that conform to a particular format. These include banks, military units and large businesses. Banks send out large numbers of statements and other documents, all using the same basic layout. The military also sends out orders with rigid formatting; a fact that aided Allied code-breakers in the efforts to crack the Enigma code. The primary objective of the present invention is to improve the security of transmission of information of these types.

### BRIEF DESCRIPTION OF THE INVENTION

The present invention is a nonmathematical method of encryption that changes the encryption key every time a unit of data, such as a byte of data, is encoded. Not only does the key change with every such unit of information, but the information itself dictates the new form that the key will take. For example, during the encoding of a message in plaintext, while a unit of data representing the letter “a” will change the key in a certain manner; a different unit of data representing the letter “b” will change it in a different manner, a still different unit of data representing the letter “c” will change the key in a still different manner, and so on for every possible input unit. Therefore, every specific change in the key is dictated by the current state of the key at the time the change is made. In short, this allows the key to change continually, depending on what it is encoding.

The fact that the cryptosystem changes its key while it is encrypting plaintext, coupled with the fact that each key change is dependent on both the key and the plaintext, gives it the name “Variable Key Encryption (VKE).” Because the method of encryption is changing throughout the message, the encrypted message is more difficult to decipher than if the encryption key had remained static throughout the encryption process. Because the key is different with every unit of plaintext encoded, it resembles a one-time pad in some respects. A one-time pad is the only encryption scheme that, in theory, is impossible to break when used properly.

The central agent in generating these pads is an adaptive double key. The key changes every time it encodes even a single character, hence it is described as adaptive. It is a double key, because the key is responsible for determining two things. One is how the plaintext is changed to make the cipher text (the responsibility that all keys have), and the other is determining how the key changes in response to each encrypted character. Because of this, each character influences the fashion in which every following character is encoded, and also the impact that those characters have on future changes until the entire plaintext message is encrypted. The key system creates a nearly unlimited number of one-time pads by continually resetting the key at choice intervals as described below.

For added security, several random characters can be added to the beginning of the plaintext to be encrypted for each packet. This creates essentially a new key for every packet and prevents code-breakers from finding patters at the beginnings of messages encrypted according to this invention. Despite the complexities of the encryption process, the same key is used for encryption and decryption, as the decryption process closely resembles encryption. This means that it incorporates a symmetric key.

The key is a four-dimensional array in the embodiment of the invention that will be used for description purposes. It can be thought of as a cube containing many boxes, with the fourth dimension delineated by the positions of the pieces of information contained within each of the boxes. The pieces of information within the boxes are used to create two-part cipher alphabets, also referred to as “look-up tables.” These alphabets determine both the way the plaintext is changed and the way that the key changes during the encoding process. In the encryption process, a portion of this cube (the “Main Cube”) is copied onto a smaller cube (the “Reader Cube”). Which part of the Main Cube is copied is determined by the values of three variables that are randomly generated every time a character from the plaintext message is encoded. Their initial values are included in each key. The cubic shape used for description is not mandatory. The key can also assume other shapes, such as a square as used in block cipher or a line.

The goal of the program used in this method is to create an alphabet of character changes, so that every prospective character in the plaintext message will have another character assigned to it in the cipher text message that constitutes the encrypted output prepared for transmission according to the practice of the invention. When the new alphabet is complete, the program will find the next character from the plaintext message that is to be encoded and change it to the corresponding letter in the new alphabet. Each character that is encoded will change the variables involved in generating the new alphabet, by a process that can be thought of as shuffling the Main Cube. This results in the generation of a new alphabet for each character of the plaintext message to be encoded. The process of changing alphabets is repeated for decryption. The same alphabets are created in the same order, but the direction of letter change is reversed. For example, if “A” had turned into “B”, “B” would be decoded into “A”.

### BRIEF DESCRIPTION OF THE DRAWING

FIG. 1 is a chart of the algorithm used in the encryption process in one possible embodiment of the invention. Other possible embodiments use the same basic process.

### DETAILED DESCRIPTION OF THE INVENTION

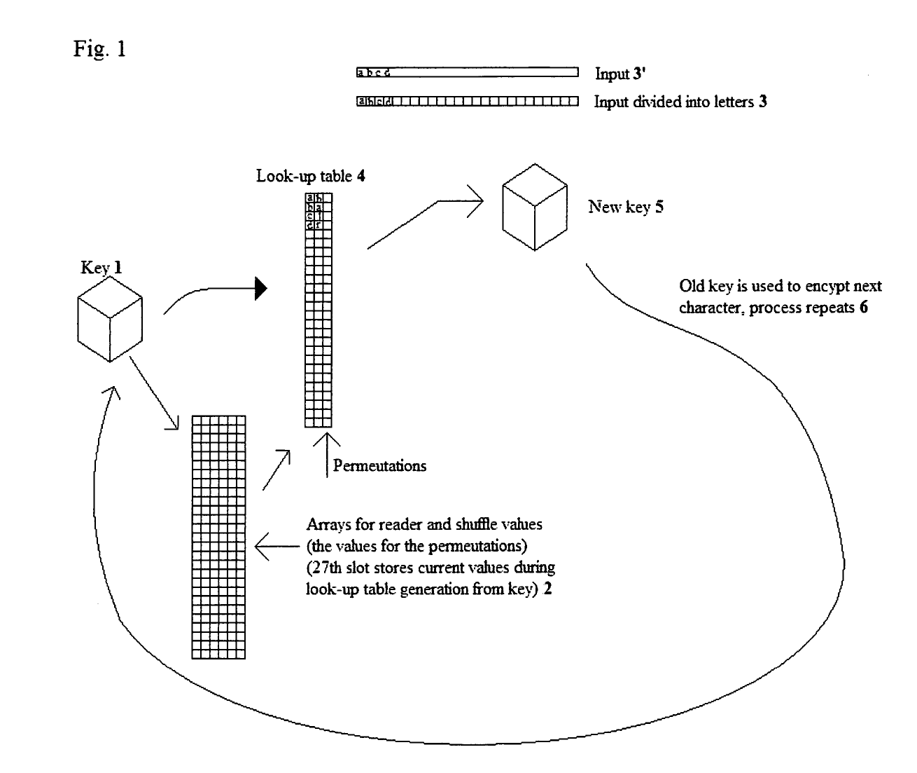

An algorithm representing the encryption process is presented as FIG. 1. Despite its novelty and complexity, the process can be represented simply for descriptive purposes. Coding Key 1 is a four-dimensional array that can be thought of as a cube, referred to here as the Main Cube, consisting of a large number of small boxes that contain information. It is not mandatory that the key as used in the invention assume that shape. Other configurations, including a square such as is used in block cipher, or a line, are feasible and should be considered as lying within the scope of the invention. The cubic shape will be used for descriptive purposes, however. Key 1 contains information that is used to encode each character of the plaintext message to be encrypted for secure transmission. A smaller cube, the Reader Cube, is located entirely within the Main Cube and is not depicted. Arrays 2 form a part of Key 1. These arrays consist of three Read arrays, which determine what parts of the Main Cube are copied onto the Reader Cube and used for each encryption step; and three Shuffle arrays, which determine how Key 1 changes during the encryption process. FIG. 2 shows these arrays as containing 27 slots each, in keeping with the embodiment of the invention that will be described. In other embodiments, the arrays will be larger, to accommodate alphabets that include numerals, punctuation marks and other symbols, along with the conventional 26 letters. The values in each of these arrays change with every unit encrypted, and a single permutation of values for each of the six arrays is stored at any given moment. The functions of the Read and Shuffle arrays will be fully explained later.

During the encryption process, the plaintext (shown as 3′) is divided into characters for encoding. Input 3 consists of these characters, represented as letters of the alphabet in the description provided. In the practice of the invention, these characters can be represented either as actual letters of the alphabet, or as units of data ranging in size from six bits to two bytes.

The values of Arrays 2 and Input 3 are both fed into Look-up Table 4. Look-up Table 4 can be considered as containing three columns. For description purposes, the first column can be considered as containing the conventional alphabet of 26 letters. In actual operation, longer “alphabets” containing numerals, punctuation marks and other symbols can be used. The second column contains a different alphabet, generated by the program, based on Key 1. This alphabet is generated by Key 1, using the values in Arrays 2, as shall be fully explained later. This new alphabet is stored in an array designated Alpha2, which will also be fully explained. The third contains the permutations of values in Arrays 2 at any given moment. In summary, Look-up Table 4 contains the conventional alphabet (one character of which will be encoded), a “new” alphabet (one character of which will correspond to the character to be encoded, and into which that character will be converted) and the permutation of values in Arrays 2 that correspond to each of the characters in the “new” alphabet in the second column of Look-up Table 4.

As each character of Input 3 is encoded, the values in Arrays 2, which are also stored in the third column of Look-up Table 4, determine how Key 1 changes in preparation to encode the next character. This altered version of the former Key 1 is represented as New Key 5. The shape of New Key 5 is the same as Key 1, but the information contained in it has been moved. Loop 6 indicates that New Key 5 has taken the place of Key 1, ready to receive new input that will change the values in the Arrays and make a new Look-up Table in order to encode the next character. This process continues until the entire plaintext message has been encrypted.

The details of the invention are contained in three programs created by the inventor in the C++ language. They are known as Keymaker, Cryptmaker and Uncrypter. The content of these programs is proprietary to the inventor, and the programs have succeeded in encoding and decoding information according to the invention described. The operation of the encryption process, as envisioned by the inventor and executed in the programs written by the inventor, will be described.

In the embodiment of the invention to be described, the key (designated 1 in FIG. 1) is a four-dimensional array. For illustrative purposes, the array should be thought of as a three-dimensional cube, m units to a side, made up of unit cubes (1×1×1). In the testing of this invention, m was set at 35, but its value can be set as high as memory space will allow. The larger the value of m, the more security the invention can provide, but the slower it will be. Each of these cubes has a number to identify it by type (1, 2 or 3, as shall be explained), and has data inside it (much like a disk with data on it). This data, represented by j, is the fourth dimension. The data locations on the key are logged in the memory as a four-dimensional array corresponding to the location of the unit cube (x/y/z coordinates) on which the data is located and the location of that data within that cube (j). As a quantity, j measures the values inside the cubes. The value of j is zero corresponding to the cube's type number, 1 to represent the first character in the cube, 2 for the second character and 3 for the third character. These characters can be thought of as located on a disk inside the cube under consideration. This disk can hold extra “hidden” values. These other values can be exposed, depending on conditions within the Cube, or in certain “shuffle” operations. The data on each disk can also be altered or moved as part of shuffle operations. Different types of “boxes” within the Cube can call for these nonstandard operations.

The first step in the encryption process is to copy the key into the RAM (Random Access Memory), so the key on the hard drive is not changed. For purposes of this description, the key as copied will be referred to as the Main Cube. There is another cube called the Reader or Reader Cube, which has the same properties as the Main Cube, only it is smaller, with x/y/z dimensions of n units, instead of m. In the testing of the invention, n was set at 30. The value of n can be increased for greater security, but n must always be less than m, the dimension of the Main Cube.

After the Key (Main Cube) is copied into the computer's RAM, a portion of the Main Cube is copied into the Reader. Since the Reader is smaller than the Main Cube, only part of the Main Cube will be copied. The part that will be copied is determined by three variables, designated reada, readb and readc. The values of these variables correspond to locations on the Main Cube where the Reader will be traveling to perform its reading operation. The initial values of these variables are randomly generated, from 0 to 9, once for every Key. Every encryption process with a certain Key file starts at the same Reader values each time. The initial values of reada, readb and readc represent the x, y and z coordinates at the place on the Main Cube where copying is to begin. Copying onto the Reader Cube continues in linear fashion. If the Reader Cube reads beyond a boundary of the Main Cube, it loops to the other end of the Main Cube and continues. This ensures that the Reader is not copying empty space.

Alternatively, the random number generation that fills in the initial values reada, readb and readc can be made to depend on input from the message to be encrypted, depicted as 3 on FIG. 1. This random number generation can be seeded with the key, encoded date, system time or a combination of these.

Once the Reader Cube has been filled, the program begins the process of making the first alphabet. Starting at (0,0,0) the program begins to search for the letters it needs, advancing first to (1,0,0) then to (2,0,0) and so on. Each time x reaches n, x is reset to zero and y is increased by 1. When y reaches n, y is reset to zero and z is increased by 1. To accommodate all relevant data on the Reader Cube, the magnitude of n must be large enough that z will never reach it.

The program searches the Reader Cube instead of the Main Cube, because the Reader Cube is smaller and does not contain every unit of information that is in the Main Cute. This allows more possible alphabets per arrangement of the Main Cube. Also, less of the workings of the key are exposed to people who would attempt to crack the code.

There are seven arrays that are filled during the process of searching the Reader Cube. The first is Alpha2 (depicted as the second column of Look-up Table 4 in FIG. 1), representing the alphabet into which the next character of the plaintext message is to be converted. The character shift functions that fill Alpha2 come from the boxes in the Main Cube designated as Type-1. Alpha2 stores the alphabet that is used to determine which character is converted into which different character, even though only one character of that alphabet will actually be used. Because the Reader is refreshed for every character to be encoded, each character is converted using a different alphabet.

It should be noted that the word “alphabet” is used generically to denote a set of characters that comprises the traditional alphabetic letters, numerals, punctuation marks and spaces. In the examples given in describing the invention, the description will pertain to the traditional 26-character alphabet. This is done for the purpose of simplifying the description of the invention, and is not intended to limit the scope of the invention. For example, if the first value of Alpha2 were Q, the letter A in the plaintext message would be converted to Q in cipher text, because A is the first letter of the conventional alphabet and Q is the first letter in Alpha2. It should also be noted that the word “alphabet” can be used to denote a look-up table of binary values, so that the code can be used to encrypt digital files. For example, a 32-character alphabet could contain all 5-bit values from 00000 to 11111, while a one byte alphabet would contain all values from 00000000 to 11111111. Working with data is faster than working with alphabetic letters and would be the preferred method of implementation for this code, but letters are used for descriptive purposes in this document.

The other six arrays, depicted as Arrays 2 in FIG. 1, consist of three Read arrays and three Shuffle arrays. The three Read arrays determine locations on the Main Cube, in x/y/z coordinates, at which the Reader Cube will operate. The three Shuffle arrays determine the manner in which the Main Cube will be changed (shuffled) after each character in the plaintext message has been encoded and before the next character is encoded. The shuffling operations rearrange the positions of unit cubes (which contain information that either converts one character to another or alters read or shuffle values associated with each possible character in the alphabet that will be generated by the action of the Reader Cube within the Main Cube). Therefore, the Main Cube is configured differently every time the Reader Cube operates within it to generate a new alphabet for the next character of the plaintext message to be encoded. This difference in the configuration of the key after each character of the plaintext message is encoded is depicted on FIG. 1 by the separate designations of Key 1 (before a character from Input 3 is encoded) and New Key 5 (after that character is encoded). Loop 6, from New Key 5 to Key 1, shows that New Key 5 takes the place of Key 1 to receive more input and encode the next character of the plaintext message.

The Read and Shuffle arrays hold alphabets of integers, corresponding to each character of the alphabet that is stored in Alpha2 in the operation of the invention. This correspondence is represented as Look-up Table 4 in FIG. 1. The size of each Read and Shuffle array is the size of the alphabet to be used, plus one. The extra slot holds a value that is the sum of all previous relevant values encountered, as will be explained. In the example that limits each alphabet to the traditional 26 letters, there are 27 integers in each such array. The Read arrays, designated readaarr, readbarr and readcarr, are used to determine the position within the Reader Cube of the next letter to be encoded. The Shuffle arrays, shufaarr, shufbarr and shufcarr, are used to shuffle the Reader Cube between letters to be encoded, so that each alphabet that is temporarily stored in Alpha2 is different for each letter of plaintext to be encoded.

When a character is selected for encoding, the values of reada, readb, readc, shufa, shufb and shufc (taken from the respective arrays) all change. The amount of change depends on which letter is to be encoded next. This creates the “variable” aspect of VKE. The value of a position in one of the Read Arrays is the sum (modulo m) of the corresponding Reader values encountered before the corresponding slot in Alpha2 is filled by a character. The same holds true for the Shuffle Arrays, except that they use the Shuffle values, which are computed modulo 10. Read and Shuffle values come from boxes designated as Type-2 and Type-3 respectively.

An example of the program in operation may help to explain the process. In this example, only plaintext consisting of traditional letters will be encoded. The program has just begun to search the Reader Cube. The boxes encountered in this example are listed in Table 1. The initial values of the Read and Shuffle variables are in the chart designated Table 2.

TABLE 1
Boxes encountered in this example

| Box # | Changes |
|---|---|
| 1 | Change F to L |
| 2 | Add 3 to reada, 4 to readb and 8 to readc |
| 3 | Change I to L (ignored in this example) |
| 4 | Change P to Z |
| 5 | Add 7 to shufa, 4 to shufb and 9 to shufc |
| 6 | Change A to V. |

The first box encountered is a letter change box (Type-1). It converts F to L. The next box is a reader change box (Type-2), which adds 3 to reada, 4 to readb and 8 to readc. The third box encountered is another letter change box. It converts I to L. Because one letter (F) already converts to L, this box is ignored. The fourth box is another letter change box, converting P to Z. The fifth box is a shuffle change (Type-3), adding 7 to shufa, 4 to shufb and 9 to shufc. The sixth box is a letter change box that converts A to V. These operations are performed in turn (unless, as in the case of the third box, the operation in that box would not aid in the process of generating the new alphabet). The partially-completed new alphabet and values associated with each letter generated at the completion of the first six boxes is shown in Table 2. A blank indicates that a letter in Alpha2 or a value in each of the Read and Shuffle arrays that will correspond with that letter will be filled in later, as the program continues to operate.

TABLE 2
Values in each of the arrays after the first six operations

| Reader array | Initial value | Values after six boxes |
|---|---|---|
| Alpha2 | | [V,_,_,_,_,L,_,_,_,_,_,_,_,_,_,Z,_,_,_,_,_,_,_,_,_,_] |
| Readaarr | Reada = 5 | [8,_,_,_,_,5,_,_,_,_,_,_,_,_,_,8,_,_,_,_,_,_,_,_,_,_] |
| Readbarr | Readb = 3 | [7,_,_,_,_,3,_,_,_,_,_,_,_,_,_,7_,_,_,_,_,_,_,_,_,_] |
| Readcarr | Readc = 2 | [10,_,_,_,_,2,_,_,_,_,_,_,_,_,_,10,_,_,_,_,_,_,_,_,_,_] |
| Shufaarr | Shufa = 8 | [15,_,_,_,_,8,_,_,_,_,_,_,_,_,_,8,_,_,_,_,_,_,_,_,_,_] |
| Shufbarr | Shufb = 6 | [10,_,_,_,_,6,_,_,_,_,_,_,_,_,_,6,_,_,_,_,_,_,_,_,_,_] |
| Shufcarr | Shufc = 4 | [13,_,_,_,_,4,_,_,_,_,_,_,_,_,_,4,_,_,_,_,_,_,_,_,_,_] |

It should be noted that Table 2 shows the state of the arrays shortly after the beginning of the process of generating a new alphabet. In the actual practice of the invention, the program keeps going until all of the slots in Alpha2 are filled with letters and all of the first 26 slots in the other six arrays are filled with numerical values associated with each of the letters in Alpha2. The 27^{th} slot of each of the arrays (except for Alpha2, which has no 27^{th} slot) keeps a running total of the value in that array, as the program encounters boxes that add to the total in the three Read arrays (Type-2) or the three Shuffle arrays (Type-3). This 27^{th} value is distinct from each of the other 26 values in each of the arrays, which represent the value at the time a letter is converted into its counterpart in Alpha2. In effect, the first through 26^{th} slots in each such array hold the totals reached when a specific letter was selected, while the 27^{th} slot holds the total after all operations associated with the filling of Alpha2 are completed. At that time, Alpha2 contains a letter for conversion of any letter in the plaintext message to be encoded. The other arrays contain values associated with each of the letters available in Alpha2 for conversion of the next letter to be encoded.

After the program has finished making the alphabet, it is told (in this example) to encode the letter A. Consulting Alpha2, the Reader turns A into V, and then adds 8 to reada, 7 to readb, 10 to readc, 15 to shufa, 10 to shufb and 13 to shufc. These are the values associated with V, the letter that was paired with A in the plaintext (note that the sixth box called for that). These values were obtained by adding the initial values, which were obtained from the key, to the quantities that were later added to the Read arrays at the second box or the Shuffle arrays at the fifth box. The new Read and Shuffle values at the 27^{th} places of the arrays are preserved. The program then clears Alpha2 and the other 26 values in the other arrays. It then shuffles the Main Cube (using the new Shuffle values from the 27^{th} place in the Shuffle arrays, as will be explained), recopies the Reader (using the new Read values from the 27^{th} place in the Read arrays) and begins to make a new alphabet for encoding the next letter of the plaintext message.

Alpha2 works differently from the other arrays. It creates and temporarily stores new alphabets. For example, [Q, R, U, H, D, A . . . ] in Alpha2 would convert an A into a Q, a B into an R, a C into a U, etc. The other arrays keep track of reader shifts that have been encountered before every letter is assigned to the new alphabet. This allows every choice of letter to have a reada value assigned to it. For example, the array readaarr=[15,12,16,6,3,12,6 . . . ] would give A a reada value of 15, B a reada value of 12, C a reada value of 16, D a reada value of 6, etc. The readb and readc values are assigned in the same way, as the Read arrays, readaarr, readbarr and readcarr are filled. The Shuffle arrays, shufaarr, shufbarr and shufcarr, are filled in the same manner. The values of shufa, shufb and shufc assigned to the chosen letter are used to shuffle the Main Cube in preparation for the creation of the next alphabet.

Every time the program checks a different box in the Reader, it checks the type-identification number associated with that box. If the number is a 2 or a 3, the program looks inside the box and finds three numbers. If the box was a Type-2, then the numbers inside represent Reader values corresponding to reada, readb and readc. If the box was a Type-3, then the numbers inside represent Shuffle values corresponding to shufa, shufb and shufc. The program adds these values to the number stored in the 27^{th} slot in each of the Read or Shuffle arrays, modulo m, for future use. When the next addition is made to Alpha2, these values will be copied of the 27^{th} slot in each of the Read and Shuffle arrays and assigned to the new letter of the alphabet as it is added. In this way, every letter of the completed alphabet would have Read and Shuffle values associated with it. When a letter in Alpha2 is selected to replace a corresponding letter in the plaintext message, these values will determine how the Reader changes and, therefore, the composition of the next alphabet to be stored in Alpha2.

If the Reader encounters a Type-1 box, the program looks inside and finds two letters. It checks to see if either of the letters has been used in the current alphabet. If neither of the letters has been used before, then it adds that combination to the new alphabet, with the first letter in the ordered pair of letters turning into the second letter in the ordered pair. In doing so, it notes the place in the alphabet held by the first letter in the ordered pair (A=1, B=2, etc.) and substitutes the second letter of the ordered pair into that place. The program then checks the 27^{th} slot of the Read and Shuffle arrays and places the values it finds there into the slots on those arrays that correspond to the ordinal value (i.e. the letter that substitutes for A corresponds to the first slot, the letter that substitutes for B corresponds to the second slot, etc.) of that letter in the new alphabet.

For example, the program finds a Type-1 box. Inside are the letters S and E. The program notes that it has no letter for S to turn into, but it does have a letter that turns into E. So it skips that box. The next box is a Type-2. Inside are the numbers 3, 9 and 4. The program then places these values (modulo m) into the 27^{th} slot of the three Read arrays. The next box is another Type-1. Inside are the letters U and K. The program notes that there is no letter assigned to U, and that no letter turns into K. The program records in Alpha2 that U (slot 21, since U is the 21^{st} letter of the alphabet) turns into K. So Alpha2 [21]=K. It then puts the numbers from the 27^{th} slot of the Read and Shuffle arrays into the 21^{th} slot (corresponding to U) of those arrays. It then goes on to the next box in the Reader Cube. If the next box is a Type-1, it will make another letter assignment as described. If the next box is a Type-2, it will add to the totals in the 27^{th} slots in the three Read arrays. If the next box is a Type-3, it will add to the total in the 27^{th} slot in the three Shuffle arrays.

This process continues until Alpha2 is filled, creating a complete alphabet. For example, Alpha2={D, I, Y, F, Z, V, A, N, G, B, L, W, O, F, X, R, C, U, H, Q, K, P, J, T, E, S}. In this example, A would turn into D, B would turn into I, C would turn into Y, etc. Once an alphabet like this has been created, it is used to encode the next letter in the message that has not yet been encoded. This alphabet will not be used again unless it occurs randomly (which is one chance in approximately 4.03×10²⁶, since there are 26! possible alphabets), and a new alphabet will be generated for the next letter to be encoded. The reason that so much processing time goes into generating alphabets is to ensure the one-to-one aspect of the alphabets. If entire alphabets were not generated for each character to be encoded, errors could result that would make the receiver of the message unable to decrypt it. For example, if Alpha2 were to contain {A, B, A etc}, then both A and C in plaintext would turn into A. Under such conditions, when a program is decrypting the message, it would see an A and not know whether that A corresponds to an A or a C. Once an alphabet has been used to encode a letter, the values for reada, readb, readc, shufa, shufb and shufc (referring to independent variables, not to the arrays in which they are placed) are set equal to the values at the locations corresponding to the order of the letters with which they are associated in the new alphabet.

In the practice of the invention, the Main Cube is shuffled after each character is encoded. The values of shufa, shufb and shufc left after the character has just been encoded are used to shuffle the Main Cube to start the process of generating a new alphabet into which the next character of the plaintext message will be encoded. This shuffling makes it more difficult for outsiders to predict the initial value of the key, and helps to ensure the highest quality of pseudo-randomness in the alphabets generated.

In the demonstration of the invention, a number was generated that determined how the Main Cube would be shuffled between characters. The values stored in the 27^{th} places of shufa, shufb and shufc at the completion of the prior alphabet (from which the letter was chosen for conversion of the previous letter in the plaintext message) are combined to produce a means for selecting a method by which the Main Cube is changed, in preparation for generating an alphabet for the next letter in the plaintext message. In this example, a function is created to generate a single-digit number (an integer between 0 and 9), which determines how the Main Cube will be changed. In the demonstration of the invention, this function was the addition of the value of shufc to the product of the values of shufa and shufb, modulo 10, otherwise expressed as [(shufa)(shufb)+shufc] mod 10. Any other operation performed on the values of shufa, shufb and shufc meets the requirements of this invention. The fact that the operation that is used is performed modulo 10 ensures that the result will be a single digit integer. The changes in the Main Cube corresponding to the numbers generated by this calculation in the demonstration of the invention are listed in Table 3. It should be noted that the operations associated with 0, 1 or 2 stagger the Main Cube; the operations associated with 6, 7 or 8 shuffle it, and the operations associated with 3, 4 or 5 do both. The operation associated with 9 changes the location of information within each of the boxes in the Main Cube, rather than shuffling or staggering the Main Cube itself. This set of shuffling operations is noted for descriptive purposes. Any other set of operations that results in the shuffling of the Main Cube also lie within the scope of the invention.

TABLE 3
Change in Main Cube corresponding to number generated

| Number | Change in Main Cube |
|---|---|
| 0 | Top and bottom halves of Main Cube would be switched |
| 1 | Left and right halves of Main Cube would be switched |
| 2 | Front and back halves of Main Cube would be switched |
| 3 | The operation for 0, followed by the operation for 6 |
| 4 | The operation for 1, followed by the operation for 7 |
| 5 | The operation for 2, followed by the operation for 8 |
| 6 | The cube would rotate so the x and y axes would switch |
| 7 | The cube would rotate so the x and z axes would switch |
| 8 | The cube would rotate so the y and z axes would switch |
| 9 | This would change the information inside the boxes that make |
| | up the Main Cube. In the Type-1 boxes, the letters changed |
| | would switch, thereby reversing the ordered pair or letters in |
| | that box. In the Type-2 boxes, values for reada, readb and readc |
| | would change by adding one, modulo m. In the Type-3 boxes, |
| | values for shufa, shufb and shufc would change by adding one, |
| | modulo 10. This essentially creates a different Main Cube. |

Other shuffles are also possible. For example, the Main Cube could be broken into slabs and the slabs intermixed, much like playing cards are shuffled. Any means of changing the Main Cube between characters to be encoded should be thought of as lying within the scope of the invention.

Other embodiments for the means of changing the Main Cube between characters are also possible. An extra measure of randomness can be imparted to the shuffling process by performing three shuffling operations, corresponding to the “units” digit of each of the numbers stored in the 27^{th} place of shufaarr, shufbarr and shufcarr. This would be an alternative to the operation described above. The price paid for the extra measure of randomness is the additional processing time and memory space for each character to be encoded.

After the Main Cube has been shuffled, the Reader Cube is refilled using the new reada, readb and readc values. This is done by copying these values from the Main Cube for the character that has just been encoded. After the Reader has been refilled, the program creates another alphabet, encodes the next character, and repeats this process until the entire message has been encrypted.

The program has done the following: it has copied the relevant part of the Main Cube onto the Reader Cube using the reada, readb and readc values to determine which area to read. The program has combed the Reader for character change operations to make an alphabet. The program has changed the next character to be encoded, shuffled the Main Cube and reset the Reader. From here, the program returns to start, unless it has completed the encryption process for the entire plaintext message.

The decryption process essentially reverses the encryption process. It is imperative that changes in the key occur in the same way when the message is being decrypted as when it was being encrypted. During the decryption process, it is possible to follow the movements of the original encryption. Indeed, the decryption program uses the exact same process as the encryption program. The only difference is the alphabet change functions in reverse.

Decryption begins at the beginning of the message that has been received in cipher text. In the decryption process, the program looks to the change made between the first and second characters of the original message and determines which character would have been converted into the other character that appeared in its place in the encrypted message. This supplies the necessary information to decode the first character of the cipher text message. The program then looks to the changes made between the second and third characters of the cipher text message, determines which character in the plaintext alphabet would have been converted into its counterpart in the cipher text message, and decodes that character. The process continues with the decoding of each successive character until the entire message is decrypted. During this process, the program applies changes to the Read and Shuffle arrays, as if each plaintext character had actually been encoded. In effect, it reverses the process that originally encoded each character, but it decodes each character in the order in which the characters were originally encoded.

An additional feature of the invention is that the key is reset as needed, according to instructions in the program. Typically, resetting is done at intervals of 256 operations. The program also recognizes operational difficulties, such as inability to deliver look-up tables that form the basis for converting one character to another in the encoding or decoding process. In that event, the key is reset to the position it originally held.

The examples used in the description of the invention pertain to use of the traditional 26-letter alphabet, with no numerals or punctuation marks. This was done to simplify description, and this use should be thought of as illustrative and not limiting the scope of the invention. By interacting directly with the zeros and ones of a file, the program would not only run faster than when working with text letters, but would also be able to encrypt all kinds of files. The use of binary coding for all characters significantly reduces running time, making the programs more efficient in future practice than they were in the demonstration of the invention.

The invention is compatible with both block ciphers and stream ciphers. The process is essentially a stream cipher, because it encoded the plaintext in small, linear pieces. It could easily be adapted to block ciphers by working on each block in pieces.

For additional security, the actual beginning of the message to be transmitted can be disguised through the addition of random numbers at the beginning of the material to be encrypted. Random number generation, or any other means for randomly generating characters to be placed at the beginning of the material to be encrypted, is acceptable. A predetermined number of random characters are added. Because every character encoded causes the key to change, this would ensure that every message had a truly unique key. If this feature were implemented, then two identical messages would appear entirely different when encrypted. This feature would also increase VKE's ability to fend off cribbing by increasing the apparent randomness of the cipher text output. When using this method, it would be very difficult for outside attackers to tell if two messages are related, which also prevents them from drawing conclusions about data transmissions that they cannot crack. The ability to add random characters to the beginnings of messages is very important, because it means that the invention can encrypt messages using randomly generated data unknown to the receiver of the message.

Another method for increasing security, with or without adding random characters at the beginning of the message to be encrypted, is to encrypt the plaintext message twice. After the plaintext message is encrypted according to the practice of the invention, the encryption process is then performed on the encrypted material. The receiver of the twice-encrypted information must then decrypt the information as received and then decrypt the result of the first iteration of decryption to yield the original message. This double-encryption process significantly increases the apparent randomness of the encryption, thereby also significantly increasing the difficulty involved in unauthorized decryption of the content of the message. It is also possible to continue encrypting the previously-encrypted material for as many operations as desired. The limit to the number of encryption operations performed is determined by the amount of memory space and processing time used for each encryption operation. However, re-encrypting too many times could result in patterns that may reveal parts of the key, but this should not be an issue unless the message is encrypted more than ten times.

There is no limit to the dimensions of the Main Cube and the Reader Cube, m and n, respectively. Tests were conducted with m set to 35 and n set to 30, in order to allow the programs to run without undue complexity or processing time. There is no reason why m and n cannot be enlarged as much as processing speed and availability of memory will permit, even to values into the hundreds, although large size means lower speeds, and the benefit of expanding the key would eventually fall of quickly. The demonstration programs for the invention were written in the C++ language as a DOS .exe programs using the .NET framework. Rewriting the programs to run as a standard exe would substantially decrease running time.

The reason for more random characters added to a message or block of a message is to make the code more like a one-time pad. One-time pads are lists of random values that are added to characters of a message. If the values are truly random, and the one-time pad is used only once, it is theoretically unbreakable. One-time pads are the only truly unbreakable codes. The random letters added to the beginning of the coded message in one embodiment of the invention create a nearly random key. Because the key has been created randomly, the program would function in essentially the same manner as a one-time pad generator. While the output generated would not be modified on a truly random basis (only one-time pads are), the output would appear so close to that state that cracking the code would be impracticable.

Expanding the values of m and n creates a vast number of possible keys. Cryptanalysts trying to compare all possible keys to crack the program would find that there are so many keys that, even if they could all be analyzed, the plaintext messages they create would cover the entire domain. That means that every possible decrypted message would be equally likely to be correct, so the cryptanalysts would gain nothing for their efforts against the program that is part of the invention.

While the illustrations given here envision the array of boxes containing coding information in the form of a cube, it is not necessary to code the information into that form. Alternatively, the array of data-containing boxes can be thought of as an array of squares, each square containing the boxes. It is the four-dimensional nature of the array that holds the pertinent information that is important. The most salient feature of the invention is that the change in the key is based on both the current key position and the last character that has just been encoded. Any embodiment that so alters the encryption key in response to plaintext data should be considered as lying within the scope of the invention. In addition, the data contained within the “boxes” comprising the key can, in alternate practice of the invention, be altered or rotated as part of shuffle or other operations. These boxes can have different impacts on alphabet generation and key alteration. For example, one box could have the effect of causing the following box to be ignored. The changes can be effected by inserting extra data into the boxes themselves, or by adding boxes to the Cube itself that are different from the Type-1 (letter change), Type-2 (change in Read arrays) or Type-3 (change in Shuffle arrays) already mentioned.

While the description of the invention has emphasized the use of a block cipher, a stream cipher can also be used. The examples should be thought of as illustrative and not limiting. Other embodiments are possible, and they should also be considered as lying within the scope of the invention.

The invention claimed is:

1. A method of encrypting plaintext messages into cipher text messages for secure transmission, through the use of a coding key; said messages to be decrypted by the receiver of said messages, comprising:
a. the generation of two look-up tables, one being used for converting the first character of the plaintext message to a corresponding character in cipher text, and the other being used for altering and rearranging said coding key, said generation of said look-up tables being accomplished by said key;
b. the use of said look-up tables to convert said first plaintext character into said first cipher text character and then to alter said coding key, based on the identity of said first plaintext character;
c. the generation of a second pair of look-up tables into which the second character of said plaintext message will be converted, said second pair of look-up tables being determined by the position of said coding key at the time said second pair of look-up tables is being generated;
d. the conversion of said second character of said plaintext message into the corresponding character belonging to said second look-up table and the subsequent alteration of said coding key, based on the identity of said second plaintext character;
e. the generation of a third pair of look-up tables into which the third character of said plaintext message will be converted and can be used to change said coding key, said third pair of look-up tables being determined by the position of said coding key at the time said third pair of look-up tables is being generated;
f. the conversion of said third character of said plaintext message into a corresponding character belonging to said third look-up table and the subsequent alteration of said coding key, based on the identity of said third plaintext character;
g. the generation of additional and different pairs of look-up tables into which each subsequent character of said plaintext message will be converted, each said succeeding pair of look-up tables being determined by the position of the coding key at the time that each of said succeeding pairs of look-up tables is being generated and the identity of each succeeding character of said plaintext message; and
h. the conversion of each of said succeeding characters that comprise said plaintext message sequentially into characters corresponding to them in said look-up tables, while continuing to alter said coding key, until every character of the entire plaintext message to be encoded has been so encoded.

2. The method as in claim 1, further comprising the decryption of said cipher text message as encrypted according to the method in claim 1 by the receiver of said cipher text message.

3. The method as in claim 1, in which the configuration of said key changes every time that a letter of the alphabet or other character is encoded.

4. The method as in claim 3, in which the configuration of the data contained within the component units comprising said key are rotated or altered as part of a shuffle or other operation, or have different effects on the generation of alphabets or further key alteration.

5. The method as in claim 3, in which the configuration of said key changes every time that a letter of the alphabet or other character is encoded, said change being dependent upon the identity of the previous letter of the alphabet or other character encoded.

6. The method as in claim 5, in which the encryption process is initiated by random number generation.

7. The method as in claim 6, in which said random number generation is seeded with said key, encoded data (or data to be encoded), system time, predetermined data from a mutually accessible source, or any combination of these.

8. The method as in claim 1, in which said key contains information, arranged in the form of a four-dimensional matrix.

9. The method as in claim 8, in which said matrix is cubic in shape, comprised of unit cubes, each of said unit cubes containing information, the orientation and availability of which can be changed within each of said unit cubes; in which said key is square in shape, such as used in block cipher; or in which said key is in the form of a line.

10. The method as in claim 1, further comprising the addition of randomly-generated characters placed at the beginning of the material to be encrypted, for encryption before the start of encryption of the actual content of the message to be transmitted.

11. The method as in claim 1, further comprising one or more repetitions of the method according to claim 1 subsequent to completion of the first application of the method according to claim 1 upon said plaintext message, said additional repetition or repetitions occurring prior to transmission of said messages.

12. A method for encryption of information wherein the encryption key changes with each succeeding unit of data encoded, in accordance with both the position of the key during the encoding of the previous unit of data and the identity of the previous unit of data encoded.

13. The method as in claim 12, in which each of said units of data is a bit, a byte or a block of data.

14. The method as in claim 13, in which said blocks of data can comprise any convenient number of bits, including 64 or 256 bits.

15. The method as in claim 13, in which said unit of data represents one character of text, such as a letter, numeral or punctuation mark.

16. The method as in claim 12, in which the position of said key changes to a specific new position whenever a character or piece of data is encoded.

17. A method for encrypting messages to be transmitted through the Internet or other media in a secure manner, for decryption by the receiver of such messages, where the improvement comprises the use of a coding key that changes to produce a new and different encryption every time a unit of data that forms part of said messages is encoded, in response to the units of data that have already been encoded and the position of said key at the time that each of said units of data are encoded.
